(19) United States
(12) Patent Application Publication
(10) Pub. No.: US 2003/0074897 A1
(43) Pub. Date: Apr. 24, 2003

(54) Drive mechanism and rotary displacer for hot air engines

(76) Inventor: Brian Rollston, Manly (AU)

Correspondence Address: D. Douglas Price, STEPTOE & JOHNSON LLP, 1330 Connecticut Ave., N.W., Washington, DC, 20036, US

(21) Appl. No.: 09/984,015

(22) Filed: Nov. 9, 2001

Related U.S. Application Data
(63) Continuation-in-part of application No. PCT/AU00/00317, filed on Apr. 13, 2000.

(51) Int. Cl. F02B 75/18; F02G 1/04; F01B 29/10

(52) U.S. Cl. 60/517; 123/56.9; 123/56.8; 60/519; 60/525

(57) ABSTRACT

A drive mechanism for use in the transmission of power from a plurality of linear reciprocating power generating elements to a rotating output element. The drive mechanism includes a drive cam member having a cam follower guiding contour extending along the cam member; a drive cam follower operatively connected to each power generating element. Each follower is adapted to engage the cam follower guiding contour throughout each reciprocation cycle of the power generating elements, the drive cam follower guiding contour following a generally sinusoidal profile on the surface of the drive cam member, the profile including a series of lobes forming peaks and troughs with intermediate regions therebetween, the peak to peak amplitude of the substantially sinusoidal profile of the cam follower guiding contour on the surface of the drive cam substantially corresponding to the stroke amplitude of the stroke of the reciprocating power generating elements. There are at least three drive cam followers spaced along the contour from one peak to an adjacent trough.

The present invention relates generally to a drive mechanism for use with powered reciprocating members. One particular application of the present invention concerns the use of the drive mechanism in Stirling engines. It will be appreciated however that the drive mechanism has other applications and may be used in conjunction with many other types of apparatus containing powered reciprocators.

The Stirling engine is named in honour of Robert Stirling, who in the early 1800s proposed a hot-air engine that was capable of converting energy into useful work. Stirling engines have in this century undergone significant analysis and development as they are seen as having a number of advantages over the common and well known internal combustion engine.

The Stirling cycle engine operates on a closed regenerative thermodynamic cycle involving periodic compression and expansion of a working fluid at different temperature levels. It typically includes the following components: one or more cylinders; a displacer and a power piston which move within the one or more cylinders; a working fluid control loop; a regenerator or other heat exchanger/cooler mechanism; and a drive mechanism. Stirling engines connected to a drive mechanism to convert linear motion of pistons into rotary motion are termed kinematic engines. Stirling kinematic engines can adopt a variety of piston/cylinder configurations including what are known as an alpha configuration, a beta configuration and a gamma configuration. In the alpha configuration, there are separate cylinders for the expansion and compression spaces and each contains a piston. In a beta configuration the displacer and power pistons run in the same cylinder and in a gamma configuration the displacers and power pistons are housed respectively in separate cylinders. In another form of Stirling engine, the reciprocating displacer piston is replaced by a rotary displacer, known as a rotary displacer engine.

While the Stirling engine in its basic form predates the internal combustion engine and has a number of applications, it has not found universal applicability due to a number of problems, including a lack of power output. If such problems could be addressed, it is generally believed that the Stirling engine could gain widespread acceptance in many applications. This is especially so in the modern era, where the features of the Stirling engine, including high thermal efficiency employing heat from any source, little or no emissions and quiet operation, make it suitable for a number of applications.

A number of drive mechanisms have been proposed for use in Stirling engines, including simple crankshafts, rhombic drives, Ross linkages, and swash plates. Cam drives have also been proposed, see for example U.S. Pat. Nos. 5,442,913 and 5,533,335. In the present invention, another drive mechanism for use with a Stirling cycle engine is described that allows some of the advantages of the Stirling cycle to be realised.

According to one aspect of the present invention there is provided a drive mechanism for use in the transmission of power from a plurality of linear reciprocating power generating elements to a rotating output element, the drive mechanism including a drive cam member having a cam follower guiding contour extending along the cam member; a drive cam follower operatively connected to each power generating element, each follower being adapted to engage the cam follower guiding contour throughout each reciprocation cycle of the power generating elements, said drive cam follower guiding contour following a generally sinusoidal profile on the surface of the drive cam member, the profile including a series of lobes forming peaks and troughs with intermediate regions therebetween, the peak to peak amplitude of the substantially sinusoidal profile of the cam follower guiding contour on the surface of the drive cam substantially corresponding to the stroke amplitude of the stroke of the reciprocating power generating elements, there being at least three drive cam followers spaced along the contour from one peak to an adjacent trough.

It is to be understood that by the term “sinusoidal” is meant any suitable profile which includes a series of peaks and troughs joined by intermediate regions; that is the profile does not necessarily need to be sinusoidal in the strict mathematical sense.

In one form of the invention, the drive cam member includes a generally cylindrical body which is rotatable about its central axis, the cam follower guiding contour extending along a surface of the cylindrical body. In one arrangement the cam follower guiding contour maybe on the outer surface of the cam body. In another arrangement the cam follower guiding contour is on the inner surface thereof. The cam follower guiding contour may for example include an upstanding member or a groove on the surface of the cam body.

The drive cam member may be operatively connected to a drive shaft such that rotation of the cam member causes rotation of the drive shaft. In one embodiment the reciprocating elements are disposed in a generally annular arrangement with each being equally circumferentially spaced from each of its adjacent reciprocating elements. In one form the reciprocating elements include pistons disposed within respective cylinders for reciprocating motion therein.

The drive mechanism may include a main body portion, the drive cam member being mounted for rotation relative thereto. The mechanism may further include a carriage associated with each drive cam follower, each cam follower being operatively connected to its associated carriage. A track may be provided on the main body, each carriage being mounted for linear movement along the track. In one form, the track includes a plurality of groups of rods, each group being associated with a respective carriage, each carriage including guide elements which are receivable on the rods for sliding movement therealong. In another form, the track includes a plurality of grooves in the main body each groove being associated with a respective carriage, each carriage being receivable within a respective groove for movement therealong.

In one application, the drive mechanism is adapted for use in a Stirling engine. The Stirling engine includes a plurality of adjacent cylinder assemblies, each cylinder assembly having associated therewith a displacer, a power piston, and a piston connecting rod extending from each piston, the power piston connecting rod having the associated drive cam follower operatively connected thereto. Each follower is adapted to engage the cam follower guiding contour throughout each reciprocation cycle of the power piston. There is further provided control means operable so that the displacer and power piston for each assembly are in selected phase with respect to one another. Advantageously the shape of the sinusoidal contour can be altered to meet selected engine parameter requirements. For example, by “flattening” the peaks and troughs so as to alter the dwell time of the displacers and power pistons the engine power output can be increased, providing the lobes remain harmonic, that is, identical in series waveform.

Preferably, the cylinder assemblies are disposed in a generally annular arrangement with each cylinder assembly being equally circumferentially spaced from each of its adjacent cylinder assemblies.

In one form, each cylinder assembly includes a cylinder with the displacer and power piston therein, the displacer being arranged to undergo a reciprocating motion. This is a typical beta configuration type engine. In this form, the displacer may include a displacer connecting rod which is concentric within the power piston connecting rod, the displacer connecting rod extending through the power piston and being disposed within the power piston connecting rod. In this form of the invention the control means includes a linking member which operatively links the displacer of one assembly with the power piston of another assembly such that the reciprocation cycles of the assemblies and the displacer and power piston for each assembly are in selected phase. In one form, the power piston connecting rod is formed at least in part from a tubular member into which the distal end of the displacer connecting rod extends.

In another form, each displacer is disposed within a separated displacer cylinder and each associated power piston is disposed within a separate power piston cylinder, the cylinders of each associated displacer and power piston being operatively connected by a gas transfer passage. This is a typical gamma configuration type engine.

There may further be provided electrically operable ball valve means in each gas transfer passage for controlling the power output.

According to one form of the invention the displacers are disposed within their associated displacer cylinder for reciprocating movement therein. In this particular form of the invention the control means may include a displacer cam member having a displacer cam follower contour extending therealong. A displacer connecting rod may be provided which extends from each displacer and has a displacer cam follower operatively connected thereto which is adapted to engage the displacer cam follower contour. The drive cam member and the displacer cam member are arranged such that the reciprocation cycles of the assemblies are in selected phase.

In the aforementioned form of the invention each of the cam members may be operatively connected to the output shaft. Rotation of the drive cam member is adapted to cause rotation of the output shaft which in turn causes rotation of the displacer cam member. Preferably, the displacer cam member is operatively connected to the output shaft through a gear train which may for example, including a plurality of planetary gears and an associated ring gear on the displacer cam member.

According to another form of the invention each of the displacers is disposed within their associated cylinders for individual rotational movement therein. In this rotary displacer form of the invention the displacers are in the form of vanes which are generally semi-circular in cross-sectional shape and extend along the cylinder and are rotatable about the longitudinal axis thereof. Preferably, the front faces of the vanes are recessed. In this rotary vane displacer form of the invention the control means includes a gear train which may include a ring gear operatively connected to the drive shaft and a series of pinion gears each being associated with a respective displacer so that rotation of the pinion gear causes rotation of the vane according to selected phase.

The above mentioned displacer vanes form a separate invention in their own right. Thus according to another aspect of the present invention there is provided a displacer for a Stirling engine, the displacer including an elongated vane which in use is mounted for rotation within a cylinder, the vane including a generally semi-circular shaped body when viewed in cross-section having a front face and a rear face which is substantially the same curvature of the cylinder with which it is associated. Preferably, the cylinder walls are knurled with rings of ridges and grooves to increase the action of the working fluid.

Preferably, the front face of each vane includes inwardly formed recesses disposed on opposite sides of the axis of rotation of the vane.

In the latter two mentioned forms of the invention the control means may further include an adjustment mechanism which is operable to control the direction of rotation of the drive output shaft by adjusting the timing of the displacers relative to their associated power pistons. The adjustment mechanism may include a planetary gear support sleeve which is connected to the drive shaft for rotation therewith. The sleeve supports the planetary gears thereon. The planetary gear support sleeve may be disposed within a ring gear support sleeve which carries a ring gear. Each sleeve may have cooperating slots therein which are adapted to receive a pin therein the pin being mounted on a plug arranged for linear movement within the sleeve. Movement of the pin may be controlled by a screw element which is operated by a control actuator.

In normal operation the drive output shaft, the sleeves, the cam member via the planetary gears and ring gears rotate as a unit. By rotation of the control actuator and screw element the pin can move upwards or downwards along the longitudinal axis of the drive output shaft thereby causing relative rotation between the two sleeves and thereby adjusting the timing of reciprocation of the displacers. As a result the engine output can be driven in a normally forward or reverse direction or adopt a neutral position.

The number of peaks of the substantially sinusoidal cam follower guiding contour sets the preferred number of cylinders of the associated Stirling engine. For instance, where the guiding surface has four peaks (i.e., a two cycle substantially sinusoidal curve configuration), the Stirling engine preferably has eight power pistons, with the cam follower of each power piston connecting rod being equally separated from its adjacent cam followers. The result is that each pair of pistons are in effect arranged 90° out of phase when undergoing reciprocation within their respective cylinders. The angular separation of the axis of each power piston connecting rod (where there are eight power connecting rods) will be 45° (See FIG. 29).

Further, in the case of an engine having eight power pistons, as each power piston will have four strokes per one revolution of the cam, the total number of power strokes of the eight power pistons is thirty two strokes per cam revolution. As the number of peaks of the guiding contour increases, so the number of power pistons that engage the drive apparatus can increase. This in turn leads to an increase in the number of power strokes per revolution of the cam as illustrated by the following table:

| | Grinding Surface | |
|---|---|---|
| Piston Number | Peaks zones | Power Strokes |
| 8 | 4 | 16 (total strokes 32) |
| 12 | 6 | 36 (total strokes 72) |
| 16 | 8 | 64 (total stokes 128) |
| 20 | 10 | 100 (total strokes 200) |

It can be readily envisaged that as the number of peaks increase, the number of power pistons that can be used to drive the drive apparatus also increase in line with the relationship described above.

One particularly advantageous application of the drive mechanism according to the invention is in relation to its use as part of an electric generator. To this end the drive cam member may be configured to form an armature which is adapted to co-operate with a stator for the generation of electricity. The drive cam member may include a plurality of permanent magnets disposed along the surface of the drive cam member which are arranged to co-operate with a stator so that relative movement between the two parts will cause electricity generation.

According to yet another aspect of the present invention there is provided a hot air engine including one or more cylinders, the or each cylinder including a first zone having associated therewith a power piston and a second zone immediately adjacent and in direct communication with the first zone and having associated therewith a displacer, the or each displacer being disposed within its associated second zone for rotational movement therein.

Preferably, the or each second zone includes a hot region and a cold region. The hot and cold regions of the or each second zone of the or each cylinder may be defined by about half of the perimeter of the or each cylinder when viewed in plan.

Preferably, the or each cylinder includes a cylinder body having the first and second zones therein. The or each cylinder body includes first and second sections operatively connected together and including bearing means generally at the junction between the sections for carrying the displacer. Preferably, the bearing means includes a plate disposed between the first and second sections of the cylinder body being arranged to support one end of the displacer, the plate having one or more apertures therein for permitting the flow of gases between the zones.

In one preferred form, each displacer is in the form of a vane which may include a vane body having a longitudinal axis about which the vane is adapted to rotate. The vane body may include a rear wall which is generally semi-circular when viewed in cross-section and a front face. The curvature of the semi-circular rear wall preferably conforms generally with the curvature of the cylinder with which it is associated so that it is a clearance fit within the cylinder. Preferably, the front face of each vane is recessed.

The engine may further include control means for controlling the movement of each displacer and its associated power piston. The control means in one preferred form includes at gear train which includes a ring gear operatively connected to a drive shaft and a pinion gear associated with a displacer so that rotation of the pinion gear causes rotation of the displacer. Preferably, the control means includes an adjustment mechanism which is operable to control the direction of rotation of the drive output shaft by adjusting the timing of the displacers relative to their associated pistons.

The hot air engine may further include a drive mechanism which includes a drive cam member having a cam follower guiding contour extending along the cam member; a drive cam follower operatively connected to the or each power piston, each follower being adapted to engage the cam follower guiding contour throughout each reciprocation cycle of the or each power piston. The drive cam follower guiding contour preferably follows a profile on the surface of the drive cam member, the profile including a series of lobes forming peaks and troughs with intermediate regions therebetween, the peak to peak amplitude of the profile of the cam following guiding contour on the surface of the drive cam substantially corresponding to the stroke amplitude of the stroke of the reciprocating power pistons. Preferably, there are at least three drive cam followers spaced along the contour from one peak to an adjacent trough. Preferably, the drive cam member includes a generally cylindrical body which is rotatable about its central axis, the cam follower guiding contour extending along a surface of the cylindrical body.

Preferably, the cylinders are disposed in a generally annular arrangement with each cylinder assembly being equally circumferentially spaced from each of its adjacent cylinders.

The engine may further include an adjustment mechanism which is operable to control the direction of rotation of the drive shaft by adjusting the timing of the displacers relative to their associated pistons. The adjustment mechanism may include an upper actuator assembly and a lower control assembly interconnected by a coupling rod.

In one preferred form, the actuator assembly includes a rotatable barrel having a first helical slot therein. The barrel is operatively connected to an actuating drum which may have a handle. The arrangement may be such that rotation of the drum causes rotation of the barrel. The assembly may further include a stator cylinder body having a first longitudinal slot therein mounted to the engine body and fixed against rotation.

The lower control assembly may, in one form include a cylindrical mounting section on an end of the drive shaft, the mounting section having a second longitudinal slot therein. The ring gear may include a cylindrical projection having a second helical groove therein, the cylindrical section being adapted to be received within the cylindrical projection.

Preferably, the upper actuator assembly and the lower control assembly are arranged for operative interconnection via the coupling rod. In one preferred form, the coupling rod includes a first pin at its upper end which when in the assembled position extends into the first slots. The lower end of the rod includes a second pin which is on a pin mounting section which is rotatable relative to the coupling rod. The second pin is receivable in the second slots when in the assembled position.

In normal operation rotation of the drive shaft will cause rotation of the ring gear thereby controlling rotation of the displacers. To adjust the timing the actuator drum is rotated by using handle which in turn causes rotation of barrel. Because first pin is disposed within the first slots the connecting rod is caused to be moved longitudinally. The longitudinal movement of the connector rod causes the second pin to track along the second longitudinal slot and cause rotation of cylindrical section of the crown gear as the pin moves along the second helical slot.

Preferred embodiments of the invention will be hereinbefore described with reference to the accompanying drawings.

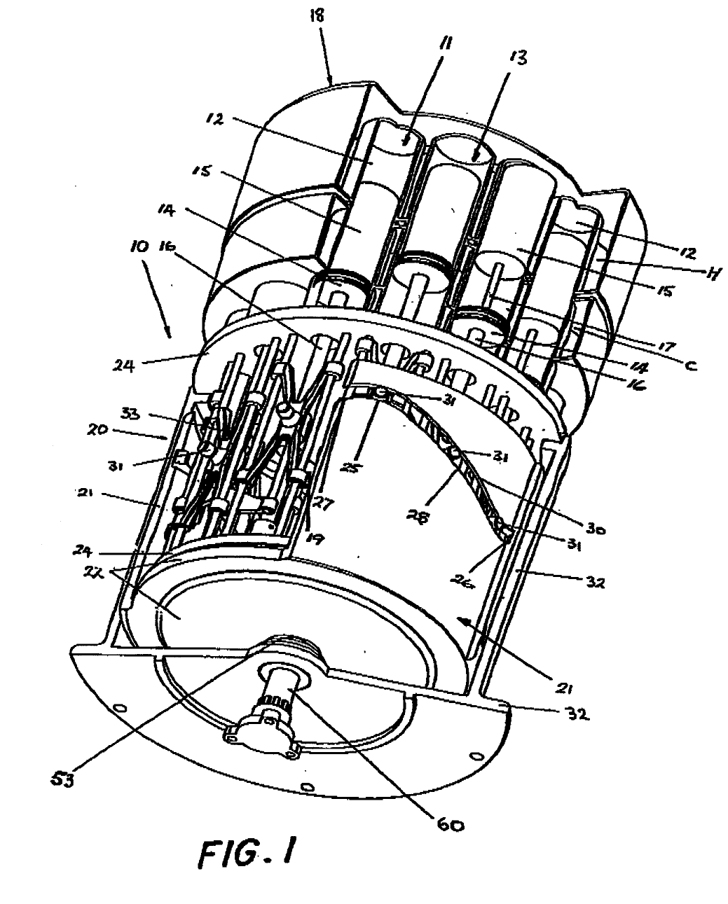

FIG. 1 is a schematic cut away perspective view of a Stirling engine according to one embodiment of the present invention;

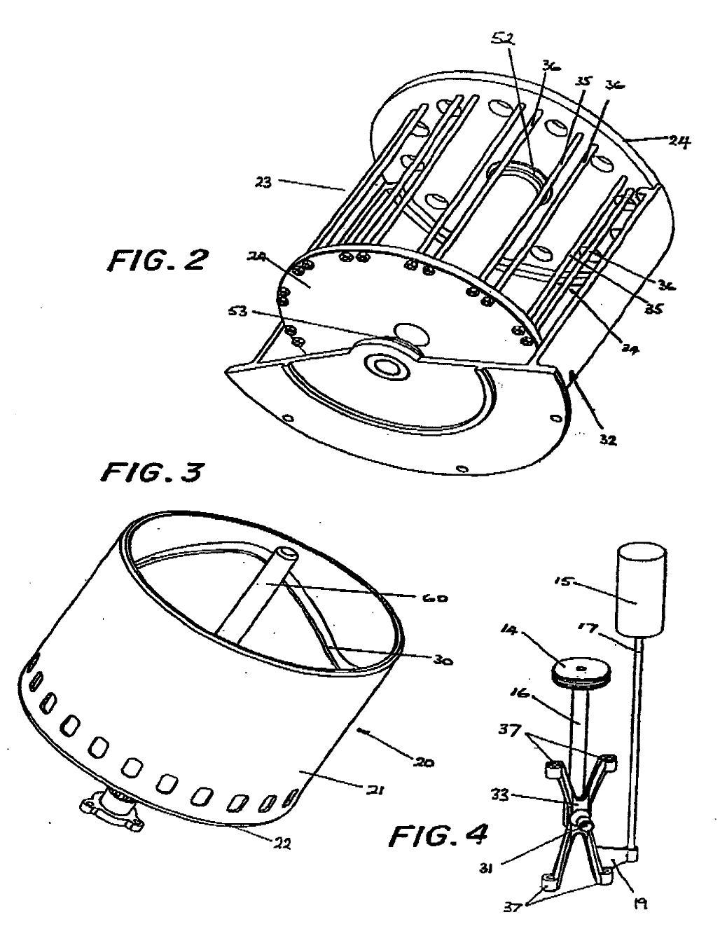

FIG. 2 is a partially cut away view of a further part of the engine shown in FIG. 1;

FIG. 3 is a schematic view of the cam member of the engine shown in FIG. 1;

FIG. 4 is a schematic view of one of the pistons and displacers of the engine shown in FIG. 1;

FIG. 5 is a cut away view of the cylinder block of the engine shown in FIG. 1;

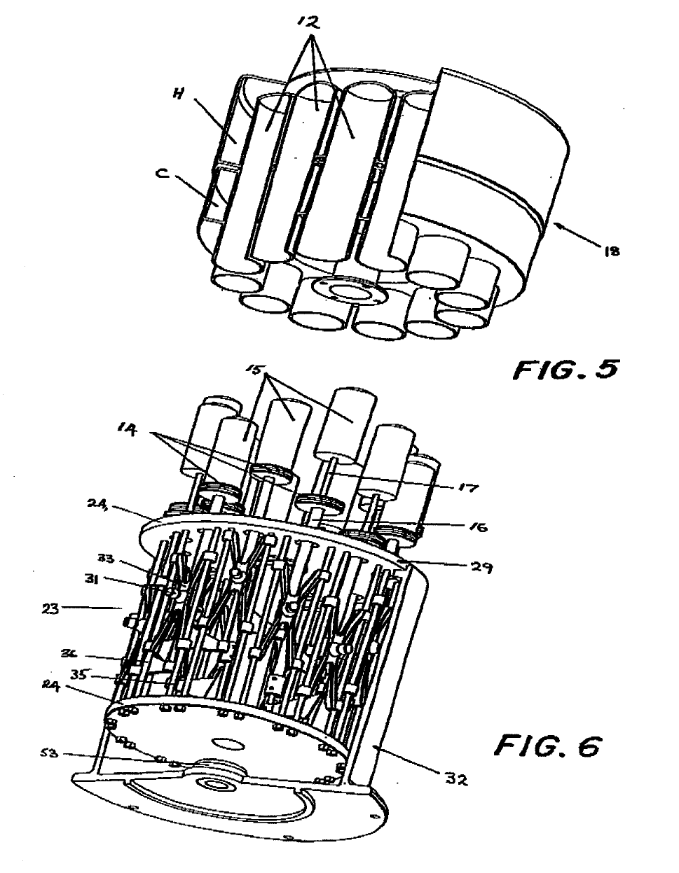

FIG. 6 is a cut away view of a further part of the engine shown in FIG. 1;

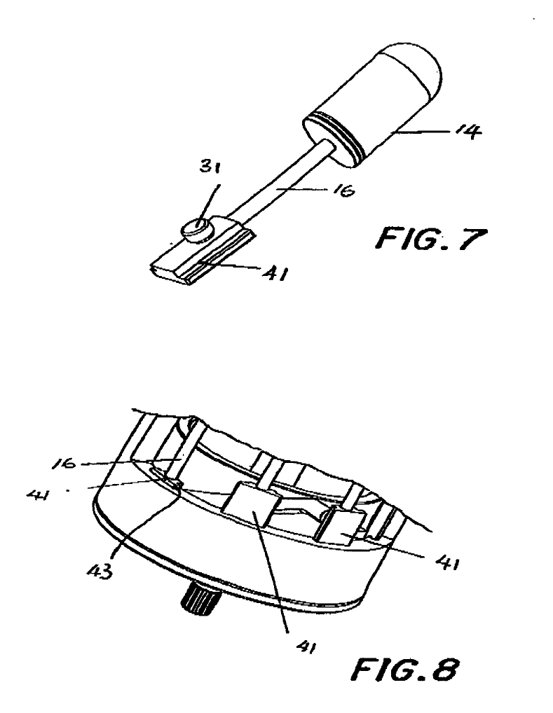

FIG. 7 is a schematic view of a T-slot form of cam follower carriage;

FIG. 8 is a schematic view of the T-slot carriage in FIG. 7 in a recessed sleeve;

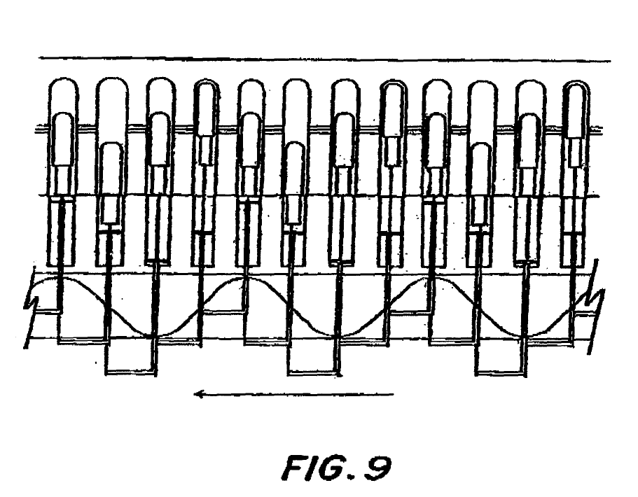

FIG. 9 is a schematic view of the engine which has been laid flat for illustrative purposes;

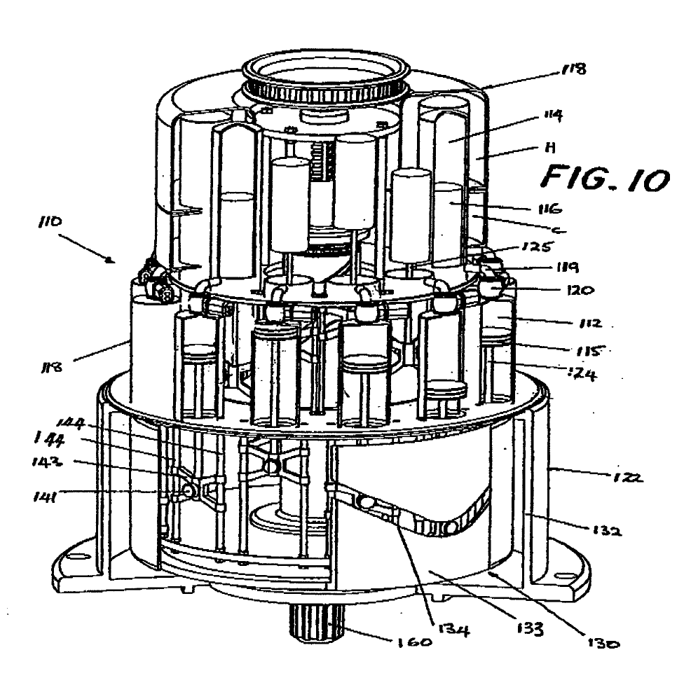

FIG. 10 is a schematic view of a Stirling engine according to a second embodiment of the present invention;

FIG. 11 is a schematic side elevation of the embodiment shown in FIG. 10;

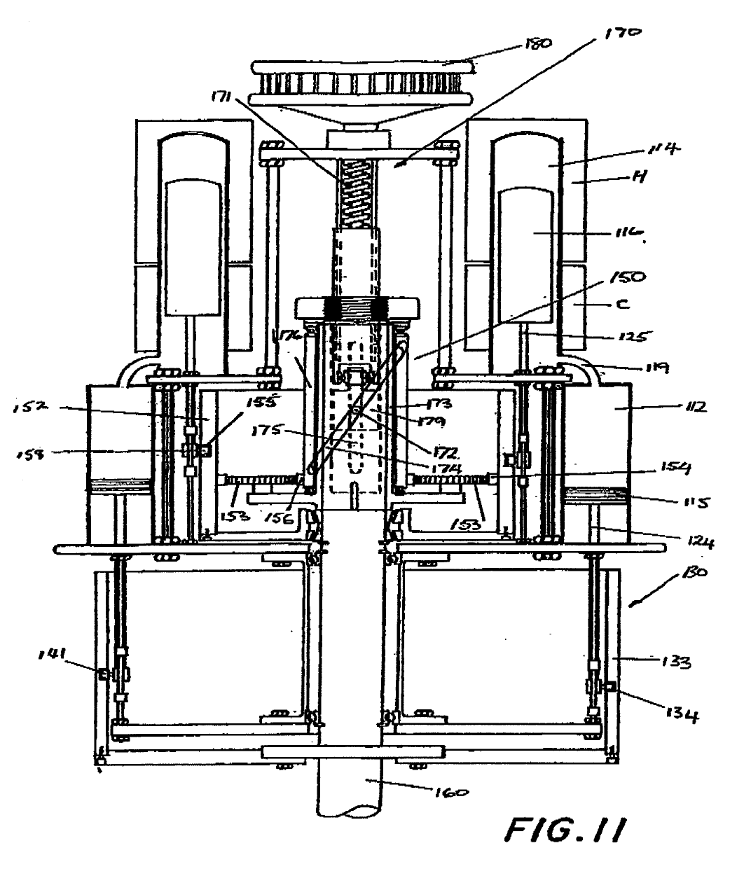

FIG. 12 is a schematic plan view of part of the engine shown in FIGS. 10 and 11;

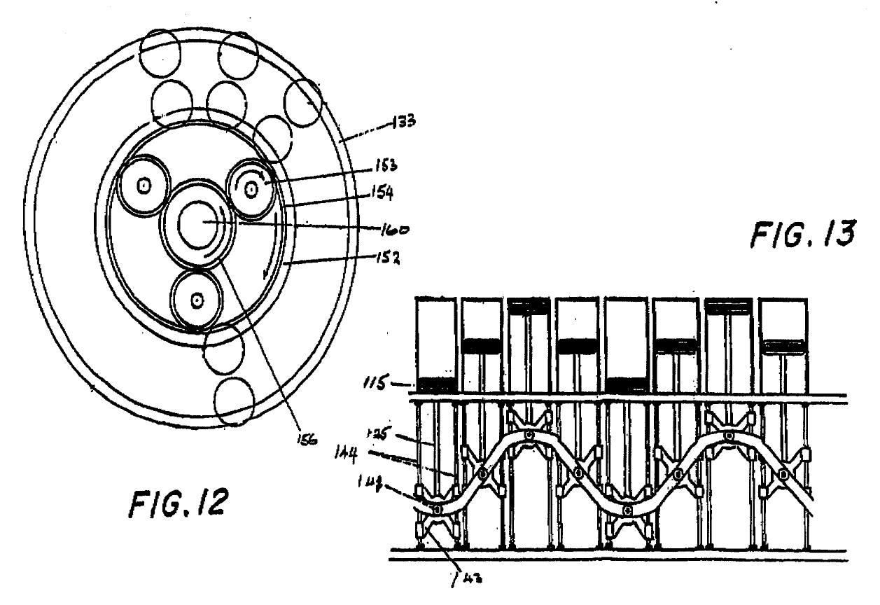

FIG. 13 is an illustration of the arrangement of adjacent pistons of the engine shown in FIGS. 10 to 12;

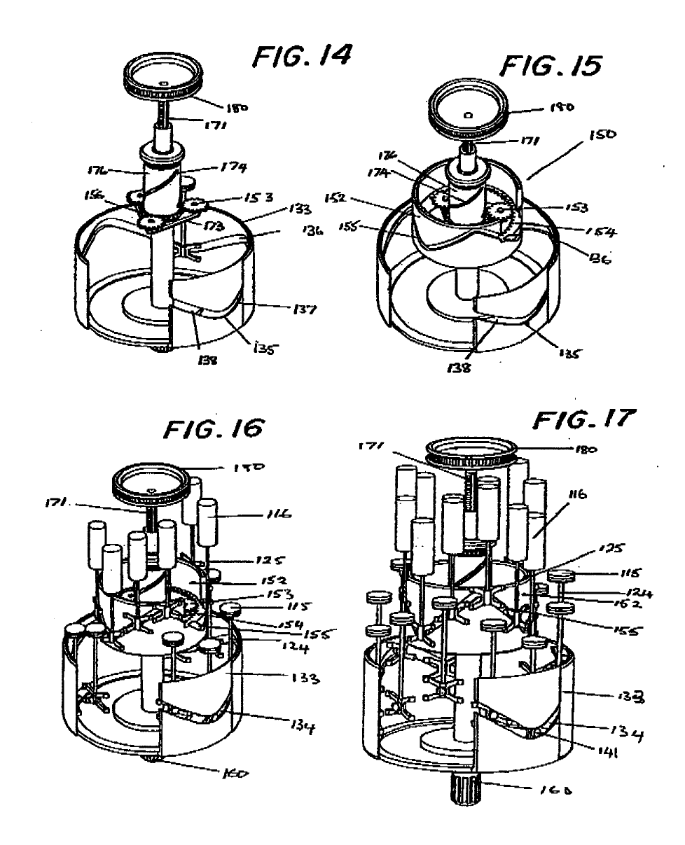

FIGS. 14 to 17 are schematic illustrations of the engine shown in FIGS. 10 to 12 with various parts removed or cut away for the purpose of illustration;

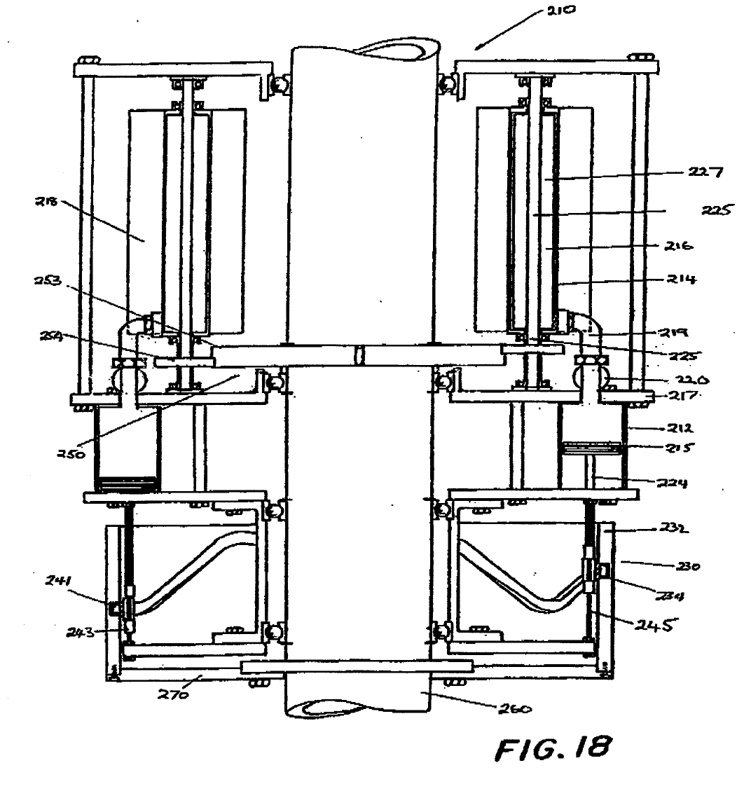

FIG. 18 is a schematic side elevation of a third embodiment of the invention;

FIG. 19 is a schematic partially cut away view of the engine shown in FIG. 18;

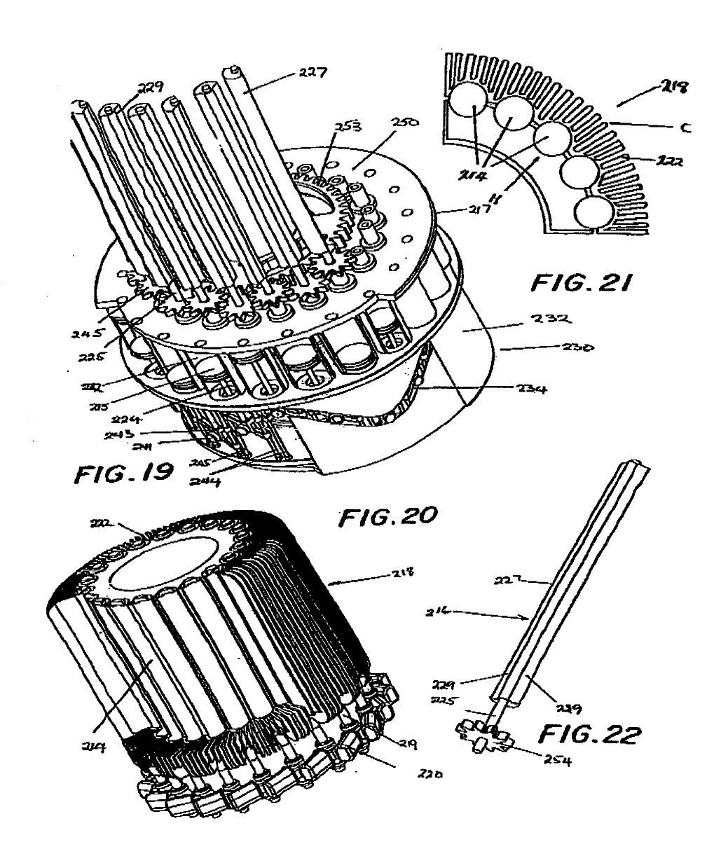

FIG. 20 is a schematic view of a typical cylinder block for engines of the type shown in FIG. 18;

FIG. 21 is a schematic plan view of part of the cylinder block showing the hot and cold zones;

FIG. 22 is a schematic view of a displacer vane for use in an engine of the type shown in FIG. 18;

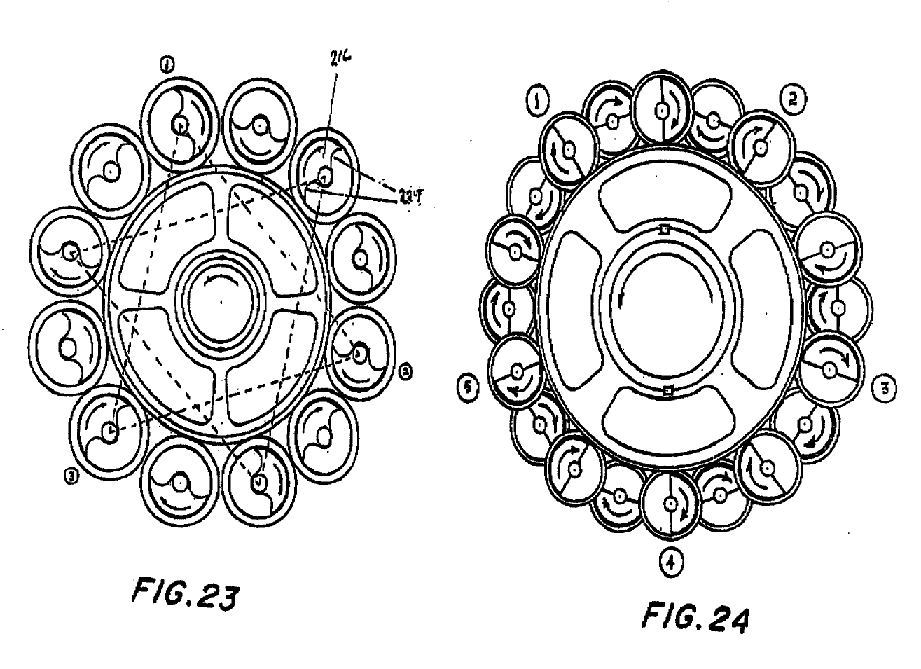

FIGS. 23 and 24 are plan views showing the timing sequence of the displacers for engines of the type shown in FIG. 18;

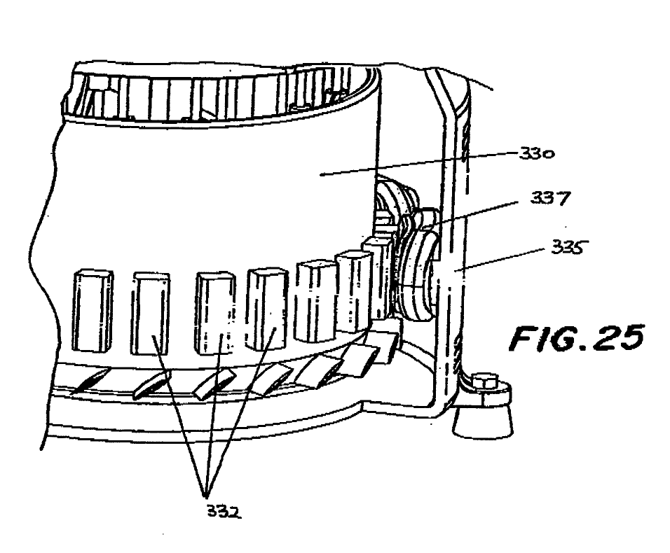

FIG. 25 is a schematic drawings illustrating the drive mechanism in a particular application where it is used as an electric generator;

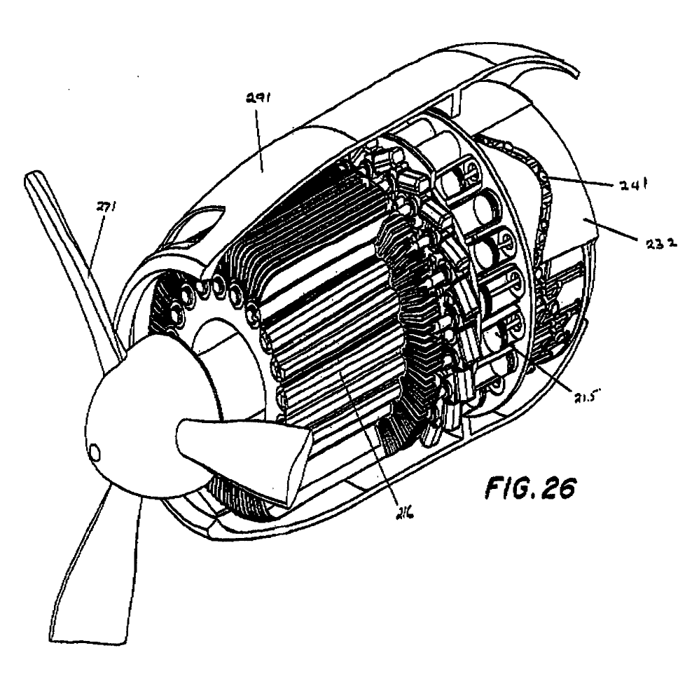

FIG. 26 is a schematic view of a further particular application of the engine of the type shown in FIG. 18;

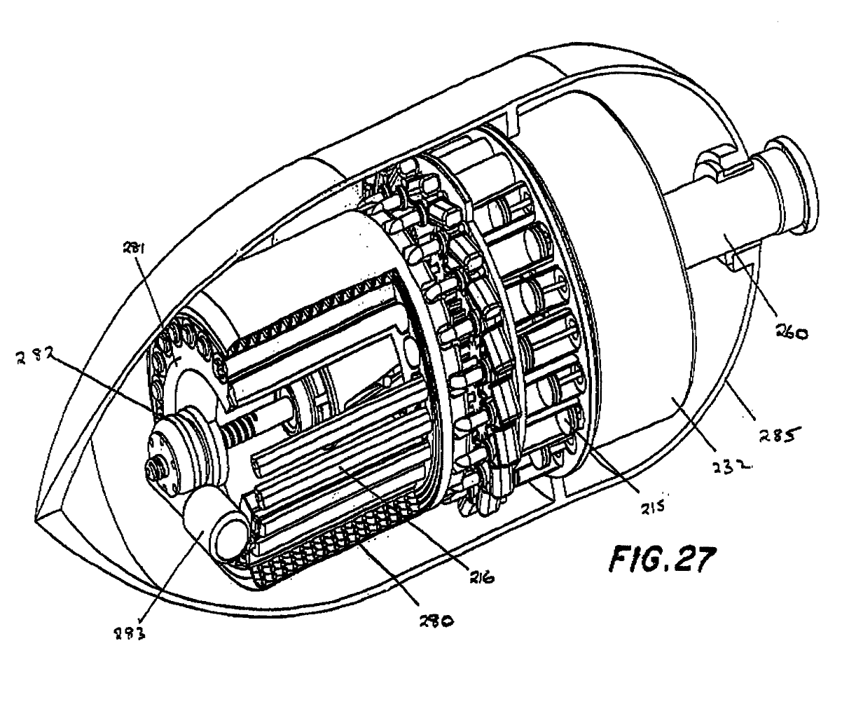

FIG. 27 is a schematic view of yet a further application of the engine of the type shown in FIG. 18;

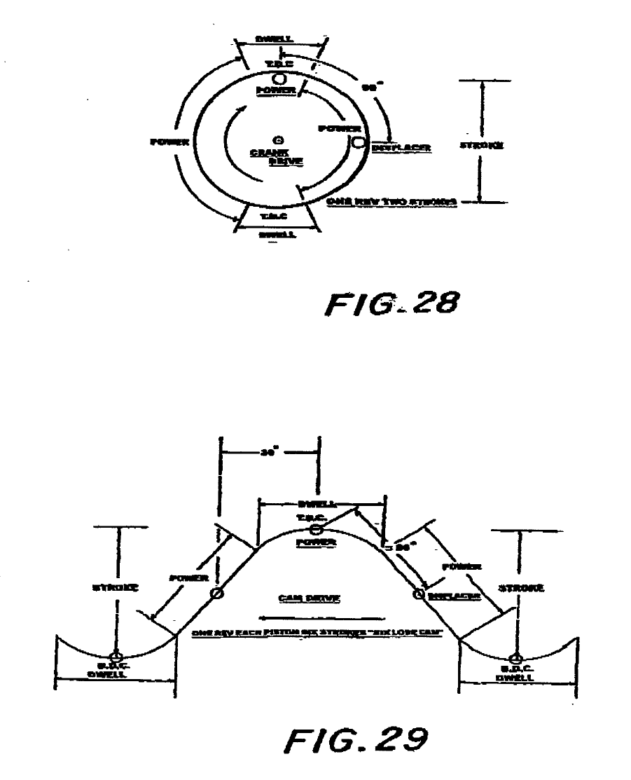

FIG. 28 is an illustration of the crank cycle for a conventional Stirling engine; and

FIG. 29 is a diagram of the cam layout for the drive mechanism according to the invention which simulates the crank cycle in FIG. 28.

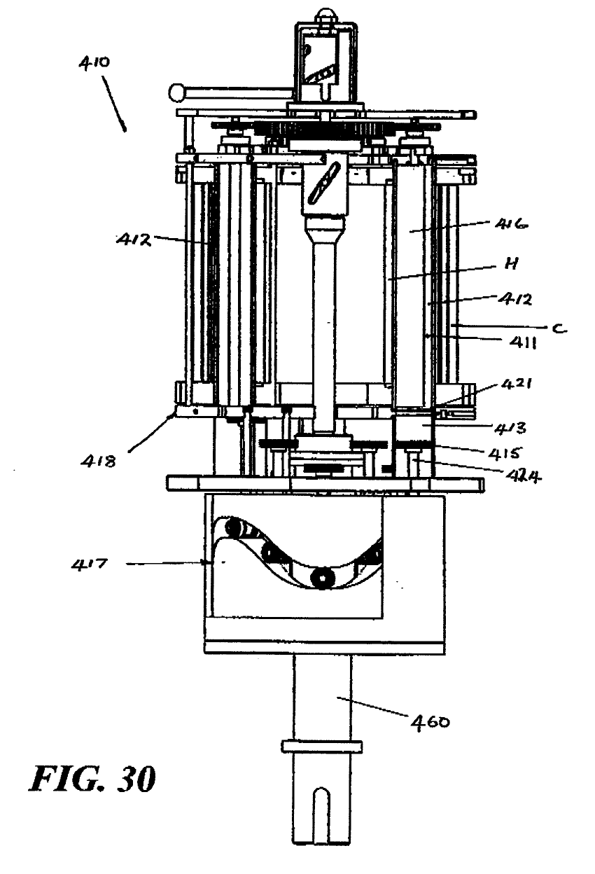

FIG. 30 is a schematic side elevation of a hot air engine according to a further preferred embodiment of the present invention;

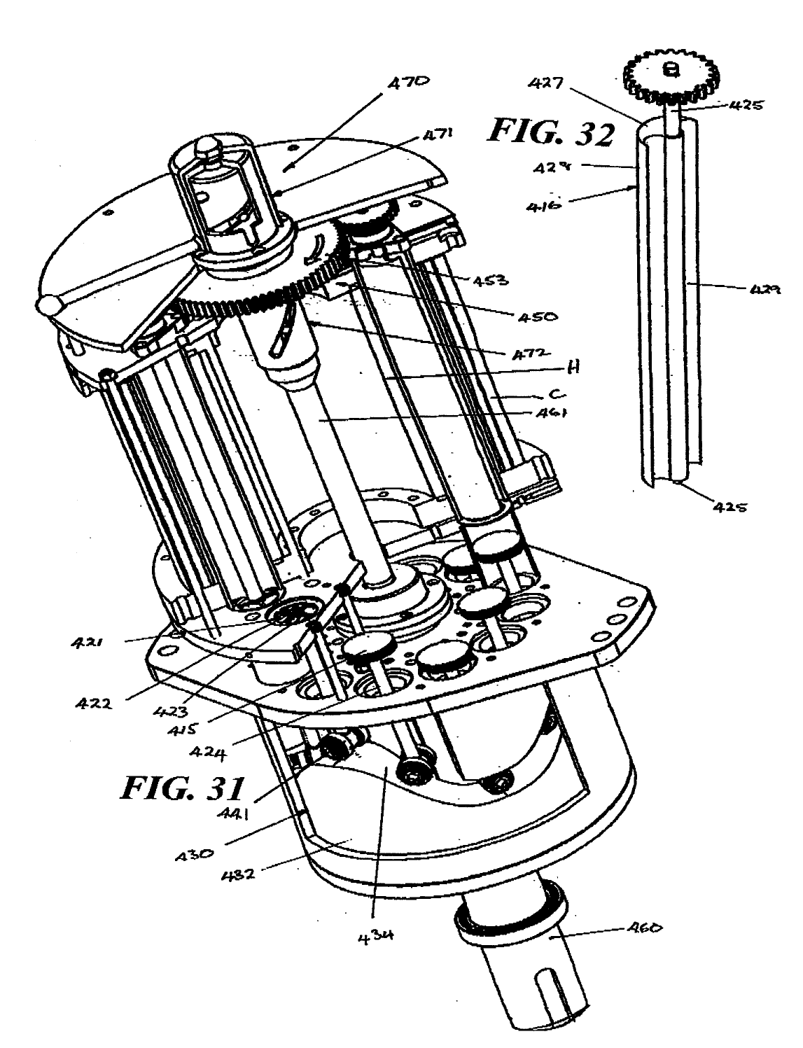

FIG. 31 is a schematic side elevation of the layout of the pistons associated with the drive mechanism according to the present invention; and

FIG. 32 is a schematic perspective view of a rotary displacer;

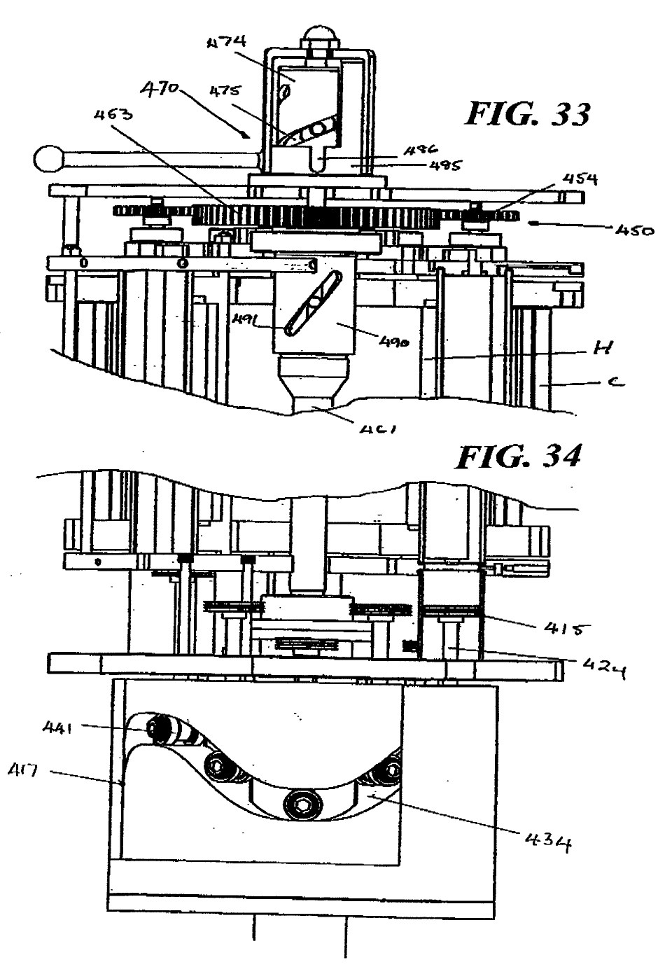

FIGS. 33 and 34 are detailed views of the two sections of the adjustment mechanism; and

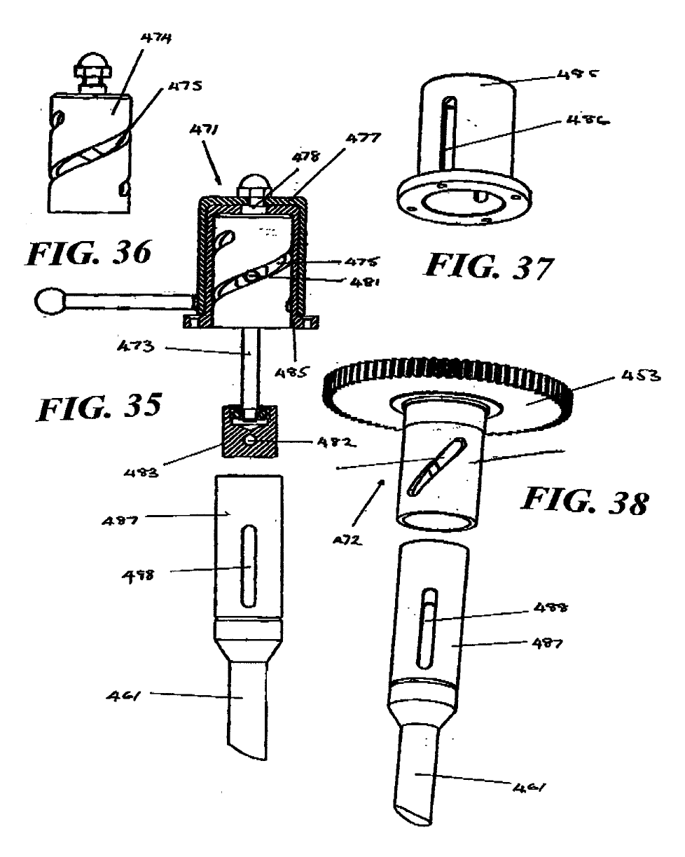

FIGS. 35 to 38 are schematic illustrations of various components of the adjustment mechanism.

Referring to FIGS. 1 to 6 of the drawings there is shown a Stirling engine incorporating a drive mechanism according to the present invention. The Stirling engine shown is in the form of a beta configuration engine. The engine generally indicated at 10 includes a cylinder block 18 with the drive mechanism 20 at one end thereof. The drive mechanism 20 includes a cylindrical rotating body 21 with a fixed base plate 22 operatively connected to the drive shaft 60. The rotating cam body 21 overlies a frame 23 which includes end plates 24 fixed to each other by a plurality of carriage rods 35 and 36. A generally cylindrical drive support shell 32 as shown in FIG. 2 overlies the fame 23 and cam body 21. The engine 10 further includes a plurality of piston/cylinder assemblies, two of which are indicated at 11 and 13.

Each assembly includes a cylinder 12 which includes two spaces or zones, each cylinder having associated therewith a power piston 14 in one space and a displacer 15 in the other space. Each power piston 14 is operatively connected to a connecting rod 16 and each displacer is operatively connected to a connecting rod 17. As shown in FIGS. 1 and 6 the displacer connecting rod 17 is disposed within the piston connecting rod 16 and moveable relative thereto. Each cylinder has a cold zone C and a hot zone H which are interconnected as is conventional in Stirling cycle engines. The engine operates on a closed regenerative cycle with a periodic compression and expansion of a working gas at different temperature levels. The displacer 15 is arranged to transfer the working gas between the hot and cold zones so that it acts on the power piston 14 as the working gas volume changes.

As is conventional in Stirling engines the displacer 15 and its associated power piston 14 in each cylinder are in effect arranged 90° out of phase with respect to one another as illustrated in FIG. 28, with the displacer leading the power piston by 90° with respect to the direction of rotation of the output shaft as shown in FIG. 29.

The particular form of engine shown in the drawings includes 12 cylinders which are arranged in a circular configuration. The assemblies are equispaced from one another by an angle θ. In the arrangement there are twelve assemblies and θ=30°. It will be appreciated that other configurations having more or less cylinders could be used, and this will be discussed in more detail below. Furthermore, although as shown the cylinders 12 are arranged in a circular or annular configuration, again it will be appreciated however that the cylinders could be arranged in other configurations such as side by side in a linear configuration, as represented in FIG. 9.

Each of the displacers 15 is operatively coupled to the power piston of an adjacent piston/cylinder assembly. This is clearly shown in FIG. 4 where the displacer 15 of one piston/cylinder assembly is operatively coupled to power piston 14 of another piston/cylinder assembly. Power piston 14 of assembly 13 leads displacer 15 of the assembly in the direction of rotation of an output shaft.

Each of the power piston connecting rods 16 is operatively connected to an output cam member 21 forming part of the drive mechanism which in turn is operatively connected to the output shaft 60.

The cam member 21 includes a generally cylindrical body (See FIG. 2) having a cam guide 30 (FIG. 3) thereon the cam body 21 (FIGS. 1 and 3) being in rotation about axis X-X. The cam guide 30 is shown on the internal surface of the body 21, however, it can be either in the internal surface or external surface of the cylindrical body 21. As shown the cam guide 30 is a continuous contour having a series of lobes 25 and 26 being the peaks or troughs of the guide with intermediate portions 27 and 28 therebetween. As can be seen the contour of the cam guide 30 is generally sinusoidal in shape.

The configuration of the various portions of the cam guide 30 can be altered to maximise the performance characteristics of the engine. For example, it is desirable that the dwell (See FIG. 29) time of the pistons be prolonged because this will create a significant gain in power. To this end the lobes 25 and 26 of the cam guide can be flattened so that their apex is not so pronounced. In addition performance can be enhanced by forming the intermediate portions so that they are generally linear. Further control can be effected by altering the slope of the intermediate portions.

Each of the power piston connecting rods 16 has a cam follower 31 associated therewith which is adapted to track along cam guide 30. The peak to trough amplitude corresponds substantially to the stroke amplitude of the power pistons 14 of the engine. As shown each peak to trough and intermediate portion of the cam guide has three power pistons 14 operatively associated therewith via connecting rods 16 and associated followers 31. Each displacer 15 is operatively coupled to the power piston 14 of the adjacent piston/cylinder assembly. Thus with a cam guide having a total of six lobes twelve displacer and power piston/cylinder assemblies are provided which are interlinked in order that the power pistons operate in sequence and for every 30° of rotation there are three power pistons undergoing expansion strokes and three power pistons undergoing compression strokes. FIG. 9 is a diagrammatic illustration of the arrangement shown in FIG. 1 with the assemblies laid out side by side with the pistons and displacer shown in their positions for each assembly.

It will be readily appreciated from the above that in a complete revolution of the cam member in the above configuration the engine produces thirty six expansion strokes and thirty six compression strokes (at is, seventy two strokes per revolution).

As described earlier, and as best seen in FIG. 1, the displacer 15 of, for example, assembly 11 is operatively coupled to the piston 14 of assembly 13. This can, for example, be effected via a coupling link 19.

As shown, an output shaft 60 extends through the centre of the engine and is supported by the drive support 32 with bearings 53.

As mentioned earlier, the cam member 21 includes a cylindrical cam body with the cam guide 30 in the form of a groove on its inner cylindrical surface. The cam body 21 is mounted to the output shaft 60 via a fixed base plate 22 and arranged such that rotation of the cam body 21 will cause rotation of the output shaft 60.

A cam follower 31 is operatively connected to a cam follower carriage 33 which is operatively connected to the power piston connecting rod 16. The cam follower carriage 33 is arranged for linear movement along a track 34 which in the form shown includes track rods 35 and 36. A coupling link 19 is operatively connected to carriage 33. FIGS. 7 and 8 show an alternative cam follower carriage, a T-slot system, which would eliminate the need for tracks 34. As shown in FIGS. 7 and 8 the power piston 14 and power piston connecting rod 16 include a carriage 41 at one end of the connecting rod 16 which has the cam follower 31 thereon. Carriage 41 in the form of a slide is receivable within T-slot 43 in a part of the mechanism body.

Referring now to FIGS. 10 to 17 of the drawings there is shown a second form of a Stirling engine incorporating a dual cam drive mechanism according to the present invention. In this case the Stirling engine is of a gamma type configuration. The engine generally indicated at 110 includes a cylinder block 118 which contains both cylinders 112 and cylinders 114. The dual cam drive mechanism includes a drive mechanism support 122 at one end thereof. The drive mechanism support 122 includes a generally cylindrical shell 132 which has a drive output shaft 160. The two groups of cylinders 112 and 114 are disposed within the cylinder block 118 one group 112 being associated with power pistons 115 and the other group 114 being associated with displacers 116. Each cylinder 114 is connected to a respective cylinder 112 by means of a gas transfer passage in the form of conduit 119. Electrically operated ball valves 120 may be disposed in each conduit 119 to control transfer of working fluid and power output.

Each cylinder 112 is adapted to receive a power piston 115 and each cylinder 114 is adapted to receive a displacer 116. Each power piston 115 is operatively connected to a connecting rod 124 and each displacer 116 is operatively connected to a connecting rod 125. Each cylinder 114 bas a cold zone C and a hot zone H as is conventional in Stirling cycle engines. She engine operates on a closed regenerative cycle with a periodic compression and expansion of a working gas at different temperature levels. The displacer 116 is arranged to transfer the working gas between the hot and cold zones so that it acts on the piston 115 as the working gas volume changes.

In the particular form of the engine shown in FIGS. 10 to 17 of the drawings the groups of cylinders are arranged in a circular configuration one above the other. The assemblies are circumferentially equispaced from one another. In an arrangement where there are twelve assemblies they are spaced from one another 30°. It will be appreciated that other configurations having more or less cylinders could be used, and this will be discussed in more detail below. Furthermore, although as shown the cylinders 114 are arranged in a circular or annular configuration, again it will be appreciated however that the cylinders could be arranged in other configurations such as side by side in a linear configuration.

As shown the drive mechanism includes a drive cam member 130 which includes a generally cylindrical body 133 having a cam guide 134 thereon, the cam member being mounted for rotation with the drive shaft 160. The cam guide 134 is shown on the internal surface of the body 133, however, it can be either in the internal surface or external surface of the cylindrical body 133. As shown the cam guide 134 is a continuous contour having a series of lobes 135 and 136 being the peaks or troughs of the guide with intermediate portions 137 and 138 therebetween. As can be seen the contour of the cam guide 134 is generally sinusoidal in shape.

The configuration of the various portions of the cam guide 134 can be altered to maximise the performance characteristics of the engine. For example, it is desirable that the dwell time of the pistons be prolonged because this will create a significant gain in power. To this end the lobes 135 and 136 of the cam guide can be flattened so that their apex is not so pronounced. In addition, performance can be enhanced by forming the intermediate portions so that they are generally linear. Further control can be effected by altering the slope of the intermediate portions.

Each of the power piston connecting rods 124 has a cam follower 141 associated therewith which is adapted to track along cam guide 134. The peak to trough amplitude corresponds substantially to the stroke amplitude of the power pistons 115 of the engine. As shown each peak to trough and intermediate portion of the cam guide has three power pistons 115 operatively associated therewith via connecting rods 124 and associated followers 141.

Each cam follower 141 is operatively connected to a cam follower carriage 143 which is operatively connected to the power piston connecting rod 124. The cam follower carriage 143 is arranged for linear movement along a track 144 which in the form shown includes track rods. As shown the carriage 143 is X-shaped.

The dual cam gamma Stirling further includes a coupling control means 150 which includes a displacer cam member 152 operatively connected to drive shaft 160 so as to rotate therewith. The cam member 152 is in the form of a cylindrical body having a cam guide 155 on the outer surface thereof. The cam guide 155 is adapted to receive cam followers 158 which are operatively connected to respective displacer connecting rods 125. The followers 158 are mounted on a carriage and track assembly similar to that described earlier with reference to the drive cam. In the particular embodiment shown the drive output shaft 160 and cam member 152 are operatively linked through a gear train which includes a series of planetary gears 153 and a ring gear 154 on the inner surface of the cam member. The reason for this manner of operative connection will become apparent from the following description of an adjustment mechanism. It will be appreciated however that the cam member 152 could be directly coupled to the drive output shaft 160. This rotation of the drive output shaft causes rotation of the cam member 152 which in turn causes reciprocation of the displacers 116.

In the particular embodiment shown and as best seen in FIGS. 11 and 15 the coupling control means 150 includes an adjustment mechanism 170 which is operable to control the direction of rotation of the drive output shaft 160 by adjusting the timing of the displacers 116 relative to their associated power pistons 115. The adjustment mechanism 170 includes a planetary gear support sleeve 173 which surrounds the drive shaft 160 and supports the planetary gears 153 on its flanged base. The planetary gear support sleeve 173 is disposed within a ring gear support sleeve 176 which carries a ring gear 156 near its base. Each sleeve 173 and 176 have cooperating slots 174 and 175 therein which are adapted to receive a pin 172 therein the pin 172 being mounted on a plug 179 arranged for linear movement within a hollow portion of the drive shaft 160. Movement of the pin 172 is controlled by screw element 171 which is operated by control actuator 180.

In normal operation the drive output shaft 160, the sleeves 173 and 176 and the cam member 152 via the planetary gears 153 and ring gears 154 and 156 rotate as a unit. By rotation of control actuator 180 and screw element 171, pin 172 can move upwards or downwards along the longitudinal axis of the drive output shaft 160 thereby causing relative rotation between the two sleeves and thereby adjusting the timing of reciprocation of the displacers 116 relative to the power pistons.

A rotary displacer gamma form of a Stirling engine incorporating a drive mechanism according to the invention is shown in FIGS. 18 and 24. With reference to the particular engine embodiment shown in FIGS. 18 and 19, the arrangement is in some ways similar to the gamma configuration shown in FIGS. 10 to 17. The major difference is that in this particular embodiment the displacers rotate rather than reciprocate and as a result the coupling control means is different and the engine employs a single cam member.

As shown in FIGS. 18 and 19 there is a Stirling engine generally indicated at 210 which includes a displacer cylinder block 218, shown in detail in FIG. 21 and a drive mechanism support plate 217 at one end thereof. The drive mechanism support plate carries a drive output shaft 260. The engine 210 further includes two groups of cylinders 212 and 214 one group 212 being associated with power pistons 215 and the other group 214 being associated with displacers 216. Each displacer cylinder 214 is connected to a respective power piston cylinder 212 by means of a gas transfer passage in the form of conduit 219. Each conduit 219 has an electrically operated ball valve 220 for controlling the transfer of working fluid and power output.

Each cylinder 212 is adapted to receive a power piston 215 and each cylinder 214 is adapted to receive a displacer 216. Each power piston 215 is operatively connected to a connecting rod 224 and each displacer 216 is operatively connected to a connecting shaft 225. Each displacer cylinder 214 has a cold zone C and a hot zone H as is conventional in Stirling cycle engines. The engine operates on a closed regenerative cycle with a periodic compression and expansion of a working fluid at different temperature levels. The displacers 216 are arranged to transfer the working fluid between the hot and cold zones so that it acts on the power pistons 215 as the working fluid volume changes.

In this particular embodiment the displacers 216 are mounted for rotation within the cylinders 214 on shafts 225 which are a central part of the displacers. The displacers 216 are in the form of vanes 227 which are generally semi-circular in shape when viewed in cross section as shown in FIGS. 19 and 22. The front faces 229 of each vane are contoured so that they are recessed inwardly and the rear face generally conforms to the curvature of the cylinder within which it is mounted. The vane 227 is configured so that it extends substantially along the full length of the cylinder 214. It will be appreciated that by extending the length of the rotary displacers power output of the engine will be increased.

The hot zone H and cold zone C of the cylinder are arranged as opposite halves of the cylinder as shown in plan view in FIG. 21. To this end that secon of the cylinder defining the cold zone C has cooling fins 222 thereon. That section of the cylinder defining the hot zone H is configured so that the cylinder wall is heated by a suitable form of heating element. The internal surface of each displacer cylinder 214, though not shown in FIGS. 20 and 21 is in a preferred form knurled with rings of ridges and grooves to increase the action of the working fluid.

The drive mechanism includes a drive cam member 230 which includes a generally cylindrical body 232 having a cam guide 234 thereon the cam body 232 which has a fixed base plate 270 arranged such that rotation of the cam body will cause rotation of the output shaft 260. As shown the cam guide 234 is a continuous contour which is generally sinusoidal in shape.

Each of the power piston connecting rods 224 has a cam follower 241 associated therewith which is adapted to track along cam guide 234. The peak to trough amplitude corresponds substantially to the stroke amplitude of the power pistons 215 of the engine. As shown in FIG. 19 each peak to trough and intermediate portion of the cam guide has three power pistons 215 operatively associated therewith via connecting rods 224 and associated followers 241.

By “flattening” the peaks and troughs of the sinusoidal cam guide, so as to alter the dwell time of the power pistons, the engine power output can be increased providing the waveform of the series of lobes remains harmonic, particularly as the rotary displacers can operate independently at or near constant full power (see FIG. 29).

A cam follower 241 is operatively connected to a cam follower carriage 243 which is operatively connected to the power piston connecting rod 224. The cam follower carriage 243 is arranged for linear movement along a track 244 which in the form shown includes track rod 245.

In the particular embodiment the coupling control means 250 includes a ring gear 253 operatively connected to drive shaft 260 for rotation therewith. The ring gear 253 is in meshing engagement with pinions 254 which are mounted on the displacer connecting shafts 225 so that rotation of the pinions attached to the displacer shafts will cause rotation of the ring gear 253 and drive shaft 260. Conversely, it will be appreciated that according to the gear control mechanism employed, as in the control in FIG. 27, the ring gear 253 may cause rotation of the pinions 254 and thereby control the timed rotation of the displacers.

In one example embodiment the engine has 20 power pistons driving a 10 lobe cam giving 100 power strokes per revolution; pulses of 5 every 18 degrees, which equals 20 pulses of 5 per revolution. The rotary vane displacer units are driven by a gear train from the main drive shaft at 5 to 1 overdrive gear ratio. The main gear drives 20 smaller gears, each one controlling the rotary vane displacer units. The rotary vane displacers each have to rotate one revolution between peaks of one side of the cam (5 off) simulating 2 strokes of a piston between peaks. In this regard refer to FIG. 24. The electrically actuated ball valves between the displacer and power cylinders, along each transfer pipe, control the power output. The unit is air cooled and electrically heated by means of a battery start which heats the cylinder wall, and after start up then operates on a dynamo from the cam drive unit. It will be appreciated that while the cam drive unit may generate electricity by the attachment of a co-axial generator to the shaft, the cam tube as in FIG. 3, may serve as a generator with attached permamagnets and surround stators. A particular form of this embodiment is shown in FIG. 25. Heat is applied to a captured area of the displacer cylinders adjacent to the central shaft of the engine.

The following table shows the various configurations relating to the number of power pistons to cam lobes and their associated degrees of activity per cycle.

| Cam Lobes | Power Pistons | Pulses | Active Pistons | Total Per Rev. |
|---|---|---|---|---|
| 4 | 8 | 8 | 2 every 45° | 16 |
| 6 | 12 | 12 | 3 every 30° | 36 |
| 8 | 16 | 16 | 4 every 22.5° | 64 |
| 10 | 20 | 20 | 5 every 18° | 100 |
| 12 | 24 | 24 | 6 every 15° | 144 |

With reference to FIG. 25 the drive apparatus is shown in a form where it can be used as an electric generator. There is shown a drive cam member 330. The drive mechanism can be of the type described with reference to any of the previously described embodiments.

As shown the drive cam member 330 has a series of permanent magnets 332 mounted to it. A portion of the outer body 335 of the mechanism has mounted thereto a series of windings or stators 337. Thus, the drive cam member 330 forms the armature of an electric generator and the body 335 houses a series of stators.

Another particular application of the engine described with reference to FIGS. 18 to 24 is in relation to its use in an air cooled aero engine and this is shown in FIG. 26.

The engine shown is substantially the same as that described with reference to FIGS. 18 to 24 and like reference numerals have been used to indicate like parts. The engine is housed within a cowling 291 and a propeller 271 is operatively connected to the output shaft.

Yet another particular application of the engine described with reference to FIGS. 18 to 24 is in relation to a sealed capsule refrigerated aerospace engine and this is shown in FIG. 27. Again parts of the engine described with reference to FIGS. 18 to 24 have been given the same reference numerals. In this application a refrigerator element 280 surrounds the displacer cylinder block 281, providing cold.

In the particular embodiment a timing device 282 alters the timing sequence between the rotary vane displacers 216 and the power pistons 215 to control the direction of rotation of the drive shaft 260, and also fine tunes the sequence at high speed revolutions.

The device is electrically controlled by means of a stepping motor worm and wheel 283 controlling a slug which travels within the drive shaft 260 with a drive pin travelling in a slot parallel in the drive shaft.

The drive pin protrudes through the slot and picks up another a lot in a sleave connected to the main drive gear; that slot is 8° off the parallel slot in the drive shaft.

The pin moves full value either way and controls which direction of rotation of the drive shaft is required, and also controls any advance for high revolutions.

The heating is electric heat, the cooling is refrigerated cooling, which means the whole unit could be a sealed unit or capsule 285 with the drive shaft out one end and an electric loom within or entering the unit which controls electrically actuated ball valves for power, and the stepping motor controlling the timing device. Preferably, the interior of the capsule 285 is maintained under fluid pressure.

Referring to FIGS. 30 to 38 of the drawings there is shown a hot air engine generally indicated at 410 which includes an engine body lock 418, a drive mechanism 417 and a drive output shaft 460. The engine 410 further includes a plurality of cylinders 412 each having a first zone 413 associated with respective power pistons 415 and a second zone 411 being associated with respective displacers 416.

Each cylinder zone 413 is adapted to receive a power piston 415 and each cylinder zone 411 is adapted to receive a displacer 416. Each power piston 415 is operatively connected to a connecting rod 424. Each cylinder zone 411 has a cold region C and a hot region H as is conventional in hot air engines. The engine operates on a closed regenerative cycle with a periodic compression and expansion of a working fluid at different temperature levels. The displacers 416 are arranged to transfer the working fluid between the hot and cold regions so that it acts on the power pistons 415 as the working fluid volume changes. As shown each cylinder includes two sections with a bearing plate 421. Each bearing plate includes a displacer mounting 422 and a series of apertures 423.

As shown the displacers 416 are mounted for rotation within the cylinder sections 411 on shafts 425 which form part of the displacers. The displacers 416 are in the form of vanes 427 which have a rear wall which is generally semi-circular in shape when viewed in cross section. The front faces 429 of each vane are contoured so that they are recessed inwardly and the rear face generally conforms to the curvature of the cylinder within which it is mounted. The vanes 427 are configured so that they extend substantially along the full length of the cylinder section 411. It will be appreciated that by extending the length of the rotary displacers power output of the engine will be increased. As shown one end of shaft 425 is support by bearing plate 421.

The hot region H and cold region C of the cylinder zones 411 are arranged as opposite halves of the cylinder when viewed in cross-section. That section of the cylinder defining the hot region H is configured so that the cylinder wall is heated by a suitable form of heating element.

As will be appreciated gases within each of the cylinder zones can pass between the zones through the apertures 423 in the bearing plate 421. Because the cylinder zones are immediately adjacent one another there is in effect no transfer zone and thus the efficiency of the engine is substantially improved.

The drive mechanism includes a drive cam member 430 which includes a generally cylindrical body 432 having a cam guide 434 thereon the cam body 432 which has a fixed blase plate 470 arranged such that rotation of the cam body will cause rotation of the output shaft 460. As shown the cam guide 434 is a continuous contour which comprises a series of peaks and troughs.

Each of the power piston connecting rods 424 has a cam follower 441 associated therewith which is adapted to track along cam guide 434. The peak to trough amplitude corresponds substantially to the stroke amplitude of the power pistons 415 of the engine. As shown each peak to trough and intermediate portion of the cam guide has three power pistons 415 operatively associated therewith via connecting rods 424 and associated followers 441.

By “flattening” the peaks and troughs of the sinusoidal cam guide, so as to alter the dwell time of the power pistons, the engine power output can be increased providing the waveform of the series of lobes remains harmonic, particularly as the rotary displacers can operate independently at or near constant full power.

As shown the engine includes control means 450 which includes a crown gear 453 operatively connected to an extension 461 of the drive shaft 460 for rotation therewith. The crown gear 453 is in meshing engagement with pinions 454 which are mounted on respective displacers so that rotation of the crown gear 453 will cause rotation of the pinions and drive shaft 460.

The engine further includes an adjustment mechanism 470 which is operable to control the direction of rotation of the drive output shaft by adjusting the timing of the displacers relative to their associated pistons. The adjustment mechanism 470 includes an upper actuator assembly 471, a lower control assembly 472 interconnected by coupling rod 473.

The actuator assembly 471 includes a rotatable barrel 474 having a helical slot 475 therein. The barrel 474 is operatively connected to actuating drum 477 which has a handle 476, the connecting being via shaft 478 such that rotation of the drum 477 causes rotation of the barrel 474. The assembly further includes a stator cylinder body 485 having a vertical slot 486 therein mounted to the engine body and fixed against rotation.

The lower control assembly 472 includes a cylindrical mounting section 487 on the end of the drive shaft extension 461, the mounting section 487 having a vertical slot 488 therein. The crown gear 453 includes a cylindrical projection 490 having a helical groove 491 therein. The cylindrical section 487 is adapted to be received within the cylindrical projection 490.

The upper actuator assembly 471 and the lower control assembly 472 are arranged for operative interconnection via the coupling rod 473. The coupling rod includes a first pin 481 at its upper end which when in the assembled position extends into the slots 475 and 486. The lower end of the rod 473 includes a second pin 482 which is on a pin mounting section 483 which is rotatable relative to coupling rod 473. The second pin 482 is receivable in slots 486 and 491 when in the assembled position.

In normal operation rotation of the drive shaft 460 will cause rotation of the ring gear 453 thereby controlling rotation of the displacers. To adjust the timing the actuator drum 477 is rotated by using handle 476 which in turn causes rotation of barrel 474. Because pin 481 is disposed within the slots 475 and 486 the connecting rod 473 is caused to be raised or lowered. Raising or lowering of the connector rod 473 causes pin 482 to track along slot 488 and cause rotation of cylindrical section 490 of the crown gear as the pin moves along helical slot 491.

Finally, it is to be understood that various alterations, modifications and/or additions may be incorporated into the various constructions and arrangements of parts without departing from the spirit or ambit of the invention.

We claim:

1. A hot air engine including a plurality of adjacent cylinder assemblies, each cylinder assembly having associated therewith a power piston and a displacer, a piston connecting rod extending from each power piston, a drive mechanism including a drive cam member having a cam follower guiding contour extending along the drive cam member; a plurality of drive cam followers each being operatively connected to a respective power piston, each drive cam follower being adapted to engage the cam follower guiding contour through each reciprocation cycle of the power pistons, said drive cam follower guiding contour following a continuous profile on the surface of the drive cam member, the profile including a series of lobes forming peaks and troughs with intermediate regions therebetween, the peak to peak amplitude of the profile of the cam follower guiding contour on the surface of the drive cam member substantially corresponding to the stroke amplitude of the stroke of the power pistons, there being at least three drive cam followers spaced along the cam follower guiding contour from one peak to an adjacent trough, control means operable so that the power piston and displacer for each cylinder assembly are in selected phase with respect to one another, a link member operatively linking the displacer of one cylinder assembly with the piston of another cylinder assembly such that the reciprocation cycles of the power pistons and displacers of each of the cylinder assemblies are in selected phase.

2. A hot air engine including a plurality of adjacent cylinder assemblies, each cylinder assembly having associated therewith a power piston and a displacer, a piston connecting rod extending from each power piston, a drive mechanism including a drive cam member having a cam follower guiding contour extending along the drive cam member; a plurality of drive cam followers each being operatively connected to a respective power piston, each drive cam follower being adapted to engage the cam follower guiding contour through each reciprocation cycle of the power pistons, said drive cam follower guiding contour following a continuous profile on the surface of the drive cam member, the profile including a series of lobes forming peaks and troughs with intermediate regions therebetween, the peak to peak amplitude of the profile of the cam follower guiding contour on the surface of the drive cam member substantially corresponding to the stroke amplitude of the stroke of the power pistons, there being at least three drive cam followers spaced along the contour from one peak to an adjacent trough, control means operable so that the power piston and displacer for each cylinder assembly are in selected phase with respect to one another, said control means including a displacer cam member having a displacer cam follower contour extending therealong, and a displacer connecting rod extending from each displacer and having a displacer cam follower operatively connected thereto which is adapted to engage the displacer cam follower contour.

3. A hot air engine including a plurality of adjacent cylinder assemblies, each cylinder assembly including a power piston cylinder associated with a reciprocating power piston and a displacer cylinder associated with a displacer, a piston connecting rod extending from each power piston, and a drive mechanism operatively connected to a drive shaft, each displacer being disposed within its associated displacer cylinder for rotational movement therein, the displacers including vanes having a rear wall which is generally semi-circular in cross-sectional shape, said vanes extending along a section of the displacer cylinder with which it is associated and being rotatable about the longitudinal axis thereof, the engine further including control means including a gear train which includes a crown gear operatively connected to the drive shaft and a series of pinion gears each being associated with a respective displacer so that rotation of the pinion gear causes rotation of the associated displacer vane, said control means being operable so that the piston and displacer for each assembly are in selected phase with respect to one another.

4. A hot air engine according to claim 3 wherein said drive mechanism includes a drive cam member having a cam follower guiding contour extending along the cam member; a plurality of drive cam followers each being operatively connected to a respective power piston, each follower being adapted to engage the cam follower guiding contour through each reciprocation cycle of the power pistons, said drive cam follower guiding contour following a continuous profile on the surface of the drive cam member, the profile including a series of lobes forming peaks and troughs with intermediate regions therebetween, the peak to peak amplitude of the profile of the drive cam follower guiding contour on the surface of the drive cam member substantially corresponding to the stroke amplitude of the stroke of the power pistons, there being at least three drive cam followers spaced along the contour from one peak to an adjacent trough.

5. A hot air engine according to any preceding claim wherein the drive cam member includes a generally cylindrical body which is rotatable about its central axis, the cam follower guiding contour extending along a surface of the cylindrical body.

6. A hot air engine according to claim 5 wherein the cam follower guiding contour is on the outer surface of the cylindrical body.

7. A hot air engine according to claim 5 wherein the cam follower guiding contour is on the inner surface of the cylindrical body.

8. A hot air engine according to claim 6 or claim 7 wherein the cam follower guiding contour includes an upstanding member or a groove on the surface of the cylindrical body.

9. A hot air engine according to any preceding claim wherein the cylinder assemblies are disposed in a generally annular arrangement with each cylinder assembly being equally circumferentially spaced from each of its adjacent cylinder assemblies.

10. A hot air engine according to any preceding claim wherein the drive cam member is operatively connected to a drive shaft such that rotation of the cam member causes rotation of the drive shaft.

11. A hot air engine according to any preceding claim, including a main body portion, said drive cam member being mounted for rotation relative thereto, a carriage associated with each drive cam follower, each drive cam follower being operatively connected to its associated carriage, a track on said main body portion, each said carriage being mounted for linear movement along said track.

12. A hot air engine according to claim 11 wherein said track includes a plurality of groups of rods, each group being associated with a respective carriage, each carriage including guide elements which are receivably on the rods for sliding movement therealong.

13. A hot air engine according to claim 11 wherein said track includes a plurality of grooves in the main body each groove being associated with a respective carriage, each carriage being receivable within a respective groove for movement therealong.

14. A hot air engine according to any one of claims 1, 2, or 5 to 13 preceding claim wherein each cylinder assembly includes a cylinder with said power piston and displacer therein, said displacer being arranged to undergo a reciprocating motion.

15. A hot air engine according to claim 14 wherein the displacer includes a displacer connecting rod which is concentric within the piston connecting rod, the displacer connecting rod extending through the piston and being disposed within the piston connecting rod.

16. A hot air engine according to claim 15 wherein the power piston connecting rod is formed at least in part from a tubular member into which the distal end of the displacer connecting rod extends.

17. A hot air engine according to any one of claims 1 to 13 wherein each power piston is disposed within a power piston cylinder and each associated displacer is disposed within a displacer cylinder, the cylinders of each associated power piston and displacer being operatively connected by a gas transfer passage.

18. A hot air engine according to any preceding claim, providing electrical generation, whereby said electricity is employed co-electrically to provide heat to power the engine, and electricity to said control actuators, and electricity to charge any start-up battery.

19. A hot air engine according to any preceding claim wherein the profile of the cam follower guiding contour has the peaks and troughs of its lobes “flattened” to increase dwell, providing the lobes remain harmonic, such that it is identical in series waveform.

20. A hot air engine according to claim 3 wherein each vane has a front face which includes inwardly formed recesses disposed on opposite sides of the axis of rotation of the vane.

21. A hot air engine according to claim 3 or claim 20 wherein the cylinder walls are formed with ridges or grooves thereon.

22. A displacer for a hot air engine, the displacer including an elongated vane which in use is mounted for rotation within a cylinder, the vane including a rear wall which is generally semi-circular when viewed in cross-section and which is substantially the same curvature of the cylinder with which it is associated.

23. A displacer according to claim 22 wherein the cylinder walls are knurled with rings of ridges and grooves to increase the action of the working fluid.

24. A displacer according to claim 22 or claim 23 each vane having a front face which includes inwardly formed recesses disposed on opposite sides of the axis of rotation of the vane.
